(19) United States
(12) Patent Application Publication
(10) Pub. No.: US 2018/0362689 A1
(43) Pub. Date: Dec. 20, 2018

(54) PROCESS FOR PREPARING AN AQUEOUS POLYMER DISPERSION

(71) Applicant: BASF SE, Ludwigshafen am Rhein (DE)

(72) Inventors: Lucia JIMENEZ GARCIA, Mannheim (DE); Carmen-Elena CIMPEANU, Ludwigshafen (DE); Marcus SEIBERT, Maxdorf (DE); Hermann SEYFFER, Heidelberg (DE); Dirk LAWRENZ, Hassloch (DE); Juergen BLAUL, Oftersheim (DE)

(73) Assignee: BASF SE, Ludwigshafen am Rhein (DE)

(21) Appl. No.: 16/060,253

(22) PCT Filed: Nov. 15, 2016
(86) PCT No.: PCT/EP2016/077660

§ 371 Date: Jun. 7, 2018

(30) Foreign Application Priority Data
Dec. 11, 2015 (EP) 15199625.3

(51) Int. Cl. C08F 220/18; C08F 2/22; C08F 220/32; C08F 220/58; C08L 33/06; C08L 97/00

(52) U.S. Cl. CPC C08F 220/18; C08F 2/22; C08F 220/32; C08J 5/12; C08L 33/06; C08L 97/005; C08F 220/58

(57) ABSTRACT

A process for preparing an aqueous dispersion of a polymer P (aqueous polymer P dispersion) by free-radically initiated aqueous emulsion polymerization.

The present invention provides a process for preparing an aqueous dispersion of a polymer P (aqueous polymer P dispersion) by free-radically initiated aqueous emulsion polymerization, which comprises polymerizing

>3% and ≤8% by weight of at least one monoethylenically unsaturated compound having at least one epoxy group and/or one N-methylol group and/or at least one compound having at least two nonconjugated ethylenically unsaturated groups (monomers A), and

≥92% and <97% by weight of further ethylenically unsaturated compounds different than the monomers A, where a polymer formed solely from these ethylenically unsaturated compounds in polymerized form would have a glass transition temperature in the range of ≥0° C. and ≤50° C. (monomers B),

where the amounts of the monomers A and B add up to 100% by weight (total amount of monomers), in the presence of ≥25% and ≤120% by weight of at least one lignin compound L, based on the total amount of monomers, and

where the monomers B do not include any ethylenically unsaturated C₃ to C₆ monocarboxylic acids and/or C₄ to C₆ dicarboxylic acids and the salts and anhydrides thereof or monoethylenically unsaturated compounds having at least one silicon-containing group, a hydroxyalkyl group or a carbonyl group.

The present invention further provides the aqueous polymer P dispersions obtainable by the process of the invention themselves, for the use thereof in processes for producing shaped bodies, and the shaped bodies themselves.

The consolidation of fibrous and/or granular substrates, more particularly in flat structures, for example fiber webs, fiberboard, chipboard or more complex three-dimensional moldings etc., is frequently accomplished by a chemical route using a polymeric binder. To increase stability, especially tear strength and thermal stability, binders comprising formaldehyde-releasing crosslinkers are frequently used. However, this gives rise to the risk of unwanted formaldehyde emission.

For avoidance of formaldehyde emissions, there have already been proposals of numerous alternatives to the binders known to date. For instance, U.S. Pat. No. 4,076,917 discloses binders which comprise polymers containing carboxylic acid or carboxylic anhydride, and β-hydroxyalkylamides as crosslinkers. A disadvantage is the relative complexity of preparation of the β-hydroxyalkylamides.

EP-A 445578 discloses panels composed of finely divided materials, for example glass fibers, in which mixtures of high molecular weight polycarboxylic acids and polyhydric alcohols, alkanolamines or polyfunctional amines function as binders.

EP-A 583086 discloses formaldehyde-free aqueous binders for production of fiber webs, especially glass fiber webs. The binders comprise a polycarboxylic acid having at least two carboxylic acid groups and in some cases also anhydride groups and a polyol. These binders require a phosphorus-containing reaction accelerator in order to achieve sufficient strengths of the glass fiber webs. It is pointed out that the presence of such a reaction accelerator can be dispensed with only when a reactive polyol is used. High-reactivity polyols specified are β-hydroxyalkylamides.

EP-A-651088 describes corresponding binders for substrates composed of cellulose fiber. These binders necessarily comprise a phosphorus-containing reaction accelerator.

EP-A 672920 describes formaldehyde-free binders, impregnating agents or coating compositions, which comprise a polymer formed to an extent of 2% to 100% by weight from an ethylenically unsaturated acid or an acid anhydride as a comonomer, and at least one polyol. The polyols are substituted triazine, triazinetrione, benzene or cyclohexyl derivatives, the polyol radicals always being in the 1,3,5 positions of the rings mentioned. In spite of a high drying temperature, these binders on glass fiber webs achieve only low wet tear strengths.

DE-A 2214450 describes a copolymer formed from 80% to 99% by weight of ethylene and 1% to 20% by weight of maleic anhydride. The copolymer is used for surface coating together with a crosslinking agent, in powder form or in dispersion in an aqueous medium. The crosslinking agent used is a polyalcohol containing amino groups. In order to bring about crosslinking, however, heating to up to 300° C. is necessary.

U.S. Pat. No. 5,143,582 discloses the production of heat-resistant nonwoven materials using a thermally curing, heat-resistant binder. The binder is free of formaldehyde and is obtained by mixing a polymer having carboxylic acid groups, carboxylic anhydride groups or carboxylic salt groups and a crosslinker. The crosslinker is a β-hydroxyalkylamide or a polymer or copolymer thereof. The polymer crosslinkable with the β-hydroxyalkylamide is, for example, formed from unsaturated mono- or dicarboxylic acids, salts of unsaturated mono- or dicarboxylic acids or unsaturated anhydrides. Self-curing polymers are obtained by copolymerizing the β-hydroxyalkylamides with monomers comprising carboxyl groups.

US-A 2004/82689 discloses formaldehyde-free aqueous binders for production of fiber webs, especially glass fiber webs, said binders consisting essentially of a polymeric polycarboxylic acid, a polyol and an imidazoline derivative. The resulting bound fiber webs are said to have reduced water absorption. There is unspecific disclosure both of nitrogen-containing and of nitrogen-free polyols, but the nitrogen-containing triethanolamine in particular is described as preferred. Specific imidazoline derivatives mentioned are reaction products of a fatty acid with aminoethylethanolamine or diethylenetriamine. The aqueous binder compositions disclosed comprise a phosphorus-containing reaction accelerator.

WO 99/09100 discloses thermally curable compositions and the use thereof as formaldehyde-free binders for production of shaped articles, said compositions, as well as an alkanolamine having at least two OH groups, a polymer 1 comprising ≤5% by weight and a further polymer 2 comprising ≥15% by weight of an α,β-ethylenically unsaturated mono- or dicarboxylic acid in polymerized form.

In addition, WO10/34645 discloses aqueous binder systems for granular and/or fibrous substrates, said binder systems, as active constituents, a polymer 1 comprising ≥5.5% by weight and ≤20% by weight of an α,β-ethylenically unsaturated mono- or dicarboxylic acid in polymerized form, a polymer 2 comprising ≥40% by weight of an α,β-ethylenically unsaturated mono- or dicarboxylic acid in polymerized form, and a polyol compound having at least two hydroxyl groups.

EP-A 2487204 discloses aqueous binders for granular and/or fibrous substrates, said binders comprising, as well as a polymer containing carboxylic acid groups and a polyol compound, essentially a salt compound. These salt-containing binder liquors have an advantageous effect on wet tear strength and the tear strength at 180° C. of the fiber webs bonded therewith.

In addition, EP-A 2502944 discloses aqueous binders for granular and/or fibrous substrates which comprise, as essential components, a polymeric polycarboxylic acid, a nitrogen-free polyol compound having at least two hydroxyl groups, and an organic nitrogen compound which is free of hydroxyl groups and has a pK_{B}≤7.

In the case of lignin-containing binder systems, the prior art which follows forms the starting point.

For instance, US-A 2009/170978 discloses binder systems based on a mixture of polysaccharides, plant proteins or lignin derivatives with an emulsion polymer comprising 5% to 40% by weight of an ethylenically unsaturated carboxylic acid in polymerized form. The polysaccharides and plant proteins are advantageously used in the form of undissolved particulate systems. There are no further details regarding the use of lignin derivatives.

US-A 2011/159768 discloses aqueous binder systems comprising lignin derivatives grafted with ethylenically unsaturated carboxylic acids, and polymers containing oxazoline groups.

By contrast, EP-A 2199320 discloses binder systems based on emulsion polymers and defatted soy flour, and the use thereof for production of composite materials. In a specific embodiment, the binders may additionally comprise lignin or lignosulfonate.

WO 2013/120752 discloses aqueous binder compositions which also comprise a dispersion polymer as well as a lignin compound, wherein the dispersion polymer comprises ≥0.1% and ≤10% by weight of at least one monoethylenically unsaturated compound having at least one silicon-containing group, an epoxy group, a hydroxyalkyl group, an N-methylol group or a carbonyl group and/or at least one compound which at least two nonconjugated ethylenically unsaturated groups and advantageously additionally also ≥0.1% and ≤4% by weight of at least one monoethylenically unsaturated C₃ to C₆ monocarboxylic acid and/or C₄-C₆ dicarboxylic acid and the salts and anhydrides thereof in polymerized form.

However, the shaped bodies produced with the compositions disclosed in the aforementioned document, especially fiber webs, are not always fully satisfactory in all mechanical properties, such as dimensional stability at elevated temperature in particular. Furthermore, there is increasing market demand for alternative formaldehyde-free or reduced-formaldehyde binder systems based on renewable raw materials.

It was an object of the present invention to provide a process for producing a specific formaldehyde-free or reduced-formaldehyde aqueous binder system based on a lignin compound for fibrous and/or granular substrates, which results in improved dimensional stabilities, improved force moduli and reduced elongations at elevated temperature in shaped bodies, such as fiber webs in particular.

Accordingly, the process defined at the outset has been found.

The conduct of free-radically initiated emulsion polymerizations of ethylenically unsaturated monomers in an aqueous medium has already been widely described and is therefore well known to the person skilled in the art [in this regard see “Emulsionspolymerisation” [Emulsion Polymerization] in Encyclopedia of Polymer Science and Engineering, volume 8, pages 659 ff. (1987); D. C. Blackley, in High Polymer Latices, volume 1, pages 35 ff. (1966); H. Warson, The Applications of Synthetic Resin Emulsions, chapter 5, pages 246 ff. (1972); D. Diederich, Chemie in unserer Zeit 24, pages 135 to 142 (1990); Emulsion Polymerisation, Interscience Publishers, New York (1965); DE-A-40 03 422 and Dispersionen synthetischer Hochpolymerer [Dispersions of Synthetic High Polymers], F. Hölscher, Springer-Verlag, Berlin (1969)]. The free-radically initiated aqueous emulsion polymerization is typically effected by dispersedly distributing the ethylenically unsaturated monomers, generally with co-use of dispersing aids, such as emulsifiers and/or protective colloids, in aqueous medium and polymerizing them using at least one water-soluble free-radical polymerization initiator. The process of the invention differs from this general procedure merely by the use of specific monomers A and B which are polymerized in the presence of a lignin compound L.

It is also a significant feature that, in the case of the aqueous polymer P dispersions obtained, the residual contents of unconverted ethylenically unsaturated monomers can be lowered using chemical and/or physical methods likewise known to a person skilled in the art [see for example EP-A 771328, DE-A 19624299, DE-A 19621027, DE-A 19741184, DE-A 19741187, DE-A 19805122, DE-A 19828183, DE-A 19839199, DE-A 19840586 and 19847115], the polymer solids contents can be adjusted to a desired value by diluting or concentrating, or the aqueous polymer P dispersions obtained can have added to them further customary added substances, for example bactericidal, foam- or viscosity-modifying additives.

Monomers A used may be any monoethylenically unsaturated compounds having at least one epoxy group and/or one N-methylol group and/or compounds having at least two nonconjugated ethylenically unsaturated groups.

Monomers A having at least one epoxy group especially include vinyloxirane, allyloxirane, glycidyl acrylate and/or glycidyl methacrylate, particular preference being given to glycidyl acrylate and/or glycidyl methacrylate.

Useful monomers A also include any monoethylenically unsaturated compounds having at least one N-methylol group, for example N-methylol amide compounds based on α,β-monoethylenically unsaturated C₃ to C₆ mono- or dicarboxamides, such as N-methylolacrylamide and N-methylolmethacrylamide in particular.

The monomers A also include compounds having at least two nonconjugated ethylenically unsaturated groups, such as vinyl, vinylidene or alkenyl groups. Particularly advantageous monomers here are the diesters of dihydric alcohols with α,β-monoethylenically unsaturated monocarboxylic acids, and among these preference is given to acrylic and methacrylic acid. Examples of monomers of this type having two nonconjugated ethylenically unsaturated double bonds are alkylene glycol diacrylates and alkylene glycol dimethacrylates, for example ethylene glycol diacrylate, propylene glycol 1,2-diacrylate, propylene glycol 1,3-diacrylate, butylene glycol 1,3-diacrylate, butylene glycol 1,4-diacrylate and ethylene glycol dimethacrylate, propylene glycol 1,2-dimethacrylate, propylene glycol 1,3-dimethacrylate, butylene glycol 1,3-dimethacrylate, butylene glycol 1,4-dimethacrylate, triesters of trihydric alcohols with α,β-monoethylenically unsaturated monocarboxylic acids, for example glycerol triacrylate, glycerol trimethacrylate, trimethylolpropane triacrylate, trimethylolpropane trimethacrylate, and also divinylbenzene, vinyl methacrylate, vinyl acrylate, allyl methacrylate, allyl acrylate, diallyl maleate, diallyl fumarate, methylenebisacrylamide, cyclopentadienyl adicrylate, Wallyl cyanurate, and triallyl isocyanurate. Especially preferred are butylene glycol 1,4-acrylate, allyl methacrylate and/or divinylbenzene, where divinylbenzene in the context of this document shall be understood to mean 1,2-divinylbenzene, 1,3-divinylbenzene and/or 1,4-divinylbenzene.

Particularly advantageously, the monomer A is selected from the group comprising N-methylolacrylamide, N-methylolmethacrylamide, glycidyl acrylate, glycidyl methacrylate, butylene glycol 1,4-diacrylate, allyl methacrylate and/or divinylbenzene.

Monomers B used may be any ethylenically unsaturated compounds different than the monomers A, although the monomers B should not include any ethylenically unsaturated C₃ to C₆ monocarboxylic acids and/or C₄ to C₆ dicarboxylic acids and the salts and anhydrides thereof or monoethylenically unsaturated compounds having at least one silicon-containing group, a hydroxyalkyl group or a carbonyl group. These monomers B are chosen in terms of type and amount such that a polymer formed solely from these ethylenically unsaturated compounds in polymerized form would have a glass transition temperature in the range of ≥0° C. and ≤50° C.

Advantageously, the monomers B are selected from the group comprising conjugated aliphatic C₄ to C₉ dienes, esters of vinyl alcohol and a C₁ to C₁₀ monocarboxylic acid, C₁- to C₁₀-alkyl acrylates, C₁- to C₁₀-alkyl methacrylates, ethylenically unsaturated C₃ to C₆ monocarbonitriles, ethylenically unsaturated C₄ to C₆ dicarbonitriles, C₅- to C₁₀-cycloalkyl acrylates and methacrylates, C₁- to C₁₀-dialkyl maleates and C₁- to C₁₀-dialkyl fumarates and vinylaromatic monomers.

C₁- to C₁₀-alkyl groups in the context of this document shall be understood to mean linear or branched alkyl radicals having 1 to 10 carbon atoms, for example methyl, ethyl, n-propyl, isopropyl, n-butyl, sec-butyl, isobutyl, tert-butyl, n-pentyl, isopentyl, tert-pentyl n-hexyl, 2-ethylhexyl, n-nonyl or n-decyl. C₅- to C₁₀-cycloalkyl groups should preferably be understood to mean cyclopentyl or cyclohexyl groups which may optionally be substituted by 1, 2 or 3 C₁- to C₄-alkyl groups.

Examples of monomers B are especially 1,3-butadiene, isoprene, vinyl acetate, vinyl propionate, ethyl acrylate, n-propyl acrylate, n-butyl acrylate, isobutyl acrylate, sec-butyl acrylate, n-hexyl acrylate, 2-ethylhexyl acrylate, n-hexyl methacrylate, 2-ethylhexyl methacrylate, methyl methacrylate, ethyl methacrylate, n-propyl methacrylate, n-butyl methacrylate, isobutyl methacrylate, sec-butyl methacrylate, n-hexyl methacrylate, 2-ethylhexyl methacrylate, di-n-butyl maleate, di-n-butyl fumarate, styrene, α-methylstyrene, o- or p-vinyltoluene, p-acetoxystyrene, p-bromostyrene, p-tert-butylstyrene, o-, m- or p-chlorostyrene, acrylonitrile, methacrylonitrile, maleonitrile and/or fumaronitrile.

Advantageously, the monomers B are selected from the group comprising 2-ethylhexyl acrylate, n-butyl acrylate, acrylonitrile, 1,4-butadiene, ethyl acrylate, vinyl acetate, methyl methacrylate, styrene and/or tert-butyl methacrylate.

It is an essential feature that the monomers B are chosen in terms of type and amount such that a polymer formed solely from these ethylenically unsaturated monomers in polymerized form would have a glass transition temperature in the range of ≥0° C. and ≤50° C. and preferably ≥5° C. and ≤30° C.

In the context of this document, glass transition temperature Tg means the limit to which the glass transition temperature tends as the molecular weight increases, according to G. Kanig (Kolloid-Zeitschrift & Zeitschrift für Polymere, Vol. 190, page 1, equation 1). In the context of this document, the Tg is determined by the DSC method (Differential Scanning calorimetry, 20 K/min, midpoint measurement, DIN 53 765). The Tg values for the homopolymers of most monomers are known and listed, for example, in Ullmann's Encyclopedia of Industrial Chemistry, VCH Weinheim, 1992, vol. 5, vol. A21, p. 169; further sources of glass transition temperatures of homopolymers are, for example, J. Brandrup, E. H. Immergut, Polymer Handbook, 1st Ed., J. Wiley, New York 1966, 2nd Ed. J. Wiley, New York 1975, and 3rd Ed. J. Wiley, New York 1989).

It is an essential feature, however, that the glass transition temperatures of noncrosslinked or merely lightly crosslinked polymers can be estimated according to Fox (T. G. Fox, Bull. Am. Phys. Soc. 1956 [Ser. II] 1, page 123 and according to Ullmann's Encyclopädie der technischen Chemie, vol. 19, page 18, 4th edition, Verlag Chemie, Weinheim, 1980) in a good approximation by the following equation:

1/Tg=x1/Tg1+x2/Tg2+ . . . xn/Tgn,

where x1, x2, . . . xn are the mass fractions of monomers 1, 2, . . . n and Tg1, Tg2, . . . Tgn are the glass transition temperatures of the respective polymers formed from just one of the monomers 1, 2, . . . n in degrees Kelvin.

It is a significant feature that the monomers B are not to include any ethylenically unsaturated C₃ to C₆ monocarboxylic acids and/or C₄ to C₆ dicarboxylic acids and the salts and anhydrides thereof or monoethylenically unsaturated compounds having at least one silicon-containing group, a hydroxyalkyl group or a carbonyl group. Compounds of this kind are disclosed, for example, inter alia, in document WO 2013/120752, page 5 lines 1 to 11, 18 to 28 and 36 to 39, and page 6 lines 24 to 34. By way of clarification, it should also be noted that, in the context of the present invention, the monomers A also should not have any silicon-containing groups, hydroxyalkyl groups or carbonyl groups, and also carboxyl, carboxylate or anhydride groups.

Advantageously in accordance with the invention, the following are used for polymerization:

| | |
|---|---|
| ≥3.5% and ≤7% by weight | of monomers A, and |
| ≥93% and ≤96.5% by weight | of monomers B. |

Particularly advantageously, however, the following are used for polymerization:

| | |
|---|---|
| ≥3.5% and ≤5.5% by | of N-methylolacrylamide, N- |
| weight | methylolmethacrylamide, glycidyl acrylate, |
| | glycidyl methacrylate, butylene glycol 1,4- |
| | diacrylate, allyl methacrylate and/or |
| | divinylbenzene, and |
| ≥94.5% and ≤96.5% by | of 2-ethylhexyl acrylate, n-butyl acrylate, |
| weight | acrylonitrile, 1,4-butadiene, ethyl acrylate, |
| | vinyl acetate, methyl methacrylate, styrene |
| | and/or tert-butyl methacrylate. |

In an especially advantageous embodiment, monomers A used are mixtures of ethylenically unsaturated compounds having at least one epoxy group and compounds having at least two nonconjugated ethylenically unsaturated groups, or combinations of ethylenically unsaturated compounds having at least one N-methylol group and compounds having at least two nonconjugated ethylenically unsaturated groups, for example glycidyl acrylate and/or glycidyl methacrylate in combination with butylene glycol 1,4-diacrylate, allyl methacrylate and/or divinylbenzene, preferably glycidyl methacrylate in combination with butylene glycol 1,4-diacrylate or N-methylolacrylamide and/or N-methylolmethacrylamide in combination with butylene glycol 1,4-diacrylate, allyl methacrylate and/or divinylbenzene, preferably N-methylolacrylamide in combination with butylene glycol 1,4-diacrylate.

According to the invention, the total amount of the monomers A and B (total amount of monomers) may be included in the initial charge in the aqueous reaction medium prior to initiation of the polymerization reaction. Alternatively, it is optionally possible to include only a portion of the monomers A and/or B in the initial charge in the aqueous reaction medium prior to initiation of the polymerization reaction, and then, after initiation of the polymerization, under polymerization conditions, to add the total amount or any remaining residual amounts during the free-radical emulsion polymerization according to their consumption in a continuous manner at constant or varying flow rates or in a discontinuous manner. It is possible here for the monomers A and B to be metered in as separate individual streams, as inhomogeneous or homogeneous (component) mixtures, or as a monomer emulsion. Advantageously, the monomers A and B are metered in in the form of a monomer mixture, especially in the form of an aqueous monomer emulsion.

However, it is a significant feature that the context of the present document, in accordance with the invention, shall also include the seed, staged and gradient modes of operation that are familiar to the person skilled in the art.

In the process of the invention, it is advantageous to use dispersing aids which keep both the monomer droplets and the polymer particles formed dispersed in the aqueous medium, and hence ensure the stability of the aqueous polymer dispersion produced. Useful dispersing aids may be not only the protective colloids typically used in the conduct of free-radical aqueous emulsion polymerization reactions but also emulsifiers.

Suitable protective colloids are, for example, polyvinyl alcohols, polyalkylene glycols, alkali metal salts of polyacrylic acids and polymethacrylic acids, gelatin derivatives or copolymers comprising acrylic acid, methacrylic acid, maleic anhydride, 2-acrylamido-2-methylpropanesulfonic acid and/or 4-styrenesulfonic acid, and the alkali metal salts thereof, but also homo- and copolymers comprising N-vinylpyrrolidone, N-vinylcaprolactam, N-vinylcarbazole, 1-vinylimidazole, 2-vinylimidazole, 2-vinylpyridine, 4-vinylpyridine, acrylamide, methacrylamide, amine-bearing acrylates, methacrylates, acrylamides and/or methacrylamides. An extensive description of further suitable protective colloids can be found in Houben-Weyl, Methoden der organischen Chemie [Methods of Organic Chemistry], volume XIV/1, Makromolekulare Stoffe [Macromolecular Substances], Georg Thieme Verlag, Stuttgart, 1961, pages 411 to 420.

It is of course also possible to use mixtures of protective colloids and/or emulsifiers. Dispersants used are frequently exclusively emulsifiers, the relative molecular weights of these typically being below 1000, by contrast with protective colloids. They may be either anionic, cationic, or nonionic. When mixtures of surface-active substances are used, the individual components must, of course, be compatible with one another, and in case of doubt this can be checked by a few preliminary experiments. Anionic emulsifiers are generally compatible with one another and with nonionic emulsifiers. The same also applies to cationic emulsifiers, whereas anionic and cationic emulsifiers are mostly not compatible with one another. An overview of suitable emulsifiers can be found in Houben-Weyl, Methoden der organischen Chemie, volume XIV/1, Makromolekulare Stoffe, Georg Thieme Verlag, Stuttgart, 1961, pages 192 to 208.

However, dispersing aids used are especially emulsifiers.

Commonly used nonionic emulsifiers are, for example, ethoxylated mono-, di- and trialkylphenols (EO level: 3 to 50, alkyl radical: C₄ to C₁₂) and ethoxylated fatty alcohols (EO level: 3 to 80; alkyl radical: C₈ to C₃₆). Examples of these are the Lutensol® A brands (C₁₂C₁₄ fatty alcohol ethoxylates, EO level: 3 to 8), Lutensol® AO brands (C₁₃C₁₅ oxo alcohol ethoxylates, EO level: 3 to 30), Lutensol® AT brands (C₁₆C₁₈ fatty alcohol ethoxylates, EO level: 11 to 80), Lutensol® ON brands (C₁₀ oxo alcohol ethoxylates, EO level: 3 to 11) and the Lutensol® TO brands (C₁₃ oxo alcohol ethoxylates, EO level: 3 to 20) from BASF SE.

Standard anionic emulsifiers are, for example, alkali metal and ammonium salts of alkyl sulfates (alkyl radical: C₈ to C₁₂), of sulfuric monoesters of ethoxylated alkanols (EO level: 4 to 30, alkyl radical: C₁₂ to C₁₈) and ethoxylated alkylphenols (EO level: 3 to 50, alkyl radical: C₄ to C₁₂), of alkylsulfonic acids (alkyl radical: C₁₂ to C₁₈) and of alkylarylsulfonic acids (alkyl radical: C₉ to C₁₈).

Suitable further anionic emulsifiers have also been found to be compounds of general formula (I)

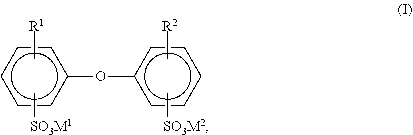

in which R¹ and R² are hydrogen atoms or C₄- to C₂₄-alkyl and are not both hydrogen atoms, and M¹ and M² may be alkali metal ions and/or ammonium ions. In the general formula (I), R¹ and R² are preferably linear or branched alkyl radicals having 6 to 18 carbon atoms, especially having 6, 12 or 16 carbon atoms, or hydrogen, where R¹ and R² are not both simultaneously hydrogen atoms. M¹ and M² are preferably sodium, potassium or ammonium, more preferably sodium. Particularly advantageous compounds (I) are those in which M¹ and M² are sodium, R¹ is a branched alkyl radical having 12 carbon atoms and R² is a hydrogen atom or R¹. Technical grade mixtures comprising a proportion of 50% to 90% by weight of the monoalkylated product, for example Dowfax® 2A1 (brand of Dow Chemical Corp.), are frequently used. The compounds (I) are common knowledge, for example from U.S. Pat. No. 4,269,749, and are commercially available.

Suitable cation-active emulsifiers are generally the following emulsifiers having a C₆- to C₁₈-alkyl or -alkylaryl or heterocyclic radical: primary, secondary, tertiary or quaternary ammonium salts, alkanolammonium salts, pyridinium salts, imidazolinium salts, oxazolinium salts, morpholinium salts, thiazolinium salts and salts of amine oxides, quinolinium salts, isoquinolinium salts, tropylium salts, sulfonium salts and phosphonium salts. Examples include dodecylammonium acetate or the corresponding sulfate, the sulfates or acetates of the various 2-(N,N,N-trimethylammonium)ethylparaffinic esters, N-cetylpyridinium sulfate, N-laurylpyridinium sulfate and N-cetyl-N,N,N-trimethylammonium sulfate, N-dodecyl-N,N,N-trimethylammonium sulfate, N-octyl-N,N,N-trimethylammonium sulfate, N,N-distearyl-N,N-dimethylammonium sulfate and the gemini surfactant N,N′-(lauryldimethyl)ethylenediamine disulfate, ethoxylated tallowalkyl-N-methylammonium sulfate and ethoxylated oleylamine (for example Uniperol® AC from BASF SE, about 11 ethylene oxide units). Numerous further examples can be found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989. It is favorable when the anionic counter-groups have minimum nucleophilicity, for example perchlorate, sulfate, phosphate, nitrate and carboxylates, for example acetate, trifluoroacetate, trichloroacetate, propionate, oxalate, citrate, benzoate, and conjugated anions of organosulfonic acids, for example methylsulfonate, trifluoromethylsulfonate and para-toluenesulfonate, and also tetrafluoroborate, tetraphenylborate, tetrakis(pentafluorophenyl)borate, tetrakis[bis(3,5-trifluoromethyl)phenyl]borate, hexafluorophosphate, hexafluoroarsenate or hexafluoroantimonate.

The emulsifiers used with preference as dispersing aids are advantageously used in a total amount of ≥0.005% and ≤10% by weight, preferably ≥0.01% and ≤5% by weight, especially ≥0.1% and ≤35 by weight, based in each case on the total amount of monomers.

The total amount of the protective colloids used as dispersing aids additionally or in place of the emulsifiers is often ≥0.1% and ≤40% by weight and frequently ≥0.2% and ≤25% by weight, based in each case on the total amount of monomers.

Preferably in accordance with the invention, however, anionic and/or nonionic emulsifiers and especially preferably anionic emulsifiers are used as the sole dispersing aids.

According to the invention, the total amount of the dispersing aids may be included in the initial charge in the aqueous reaction medium prior to initiation of the polymerization reaction. Alternatively, it is optionally possible to include only a portion of the dispersing aids in the initial charge in the aqueous reaction medium prior to initiation of the polymerization reaction, and then, under polymerization conditions, to add the total amount or any remaining residual amount of the dispersing aids during the free-radical emulsion polymerization in a continuous or discontinuous manner. Preferably, the main amount (i.e. ≥50% by weight) or the total amount of the dispersing aids is added in the form of an aqueous monomer emulsion.

The free-radically initiated aqueous emulsion polymerization is triggered by means of a free-radical polymerization initiator (free-radical initiator). These may in principle be peroxides or azo compounds. Of course, redox initiator systems are also useful. Peroxides used may, in principle, be inorganic peroxides, such as hydrogen peroxide or peroxodisulfates, such as the mono- or di-alkali metal or ammonium salts of peroxodisulfuric acid, for example the mono- and disodium, -potassium or ammonium salts, or organic peroxides such as alkyl hydroperoxides, for example tert-butyl hydroperoxide, p-menthyl hydroperoxide or cumyl hydroperoxide, and also dialkyl or diaryl peroxides, such as di-tert-butyl or di-cumyl peroxide. Azo compounds used are essentially 2,2′-azobis(isobutyronitrile), 2,2′-azobis(2,4-dimethylvaleronitrile) and 2,2′-azobis(amidinopropyl) dihydrochloride (AIBA, corresponds to V-50 from Wako Chemicals). Suitable oxidizing agents for redox initiator systems are essentially the peroxides specified above. Corresponding reducing agents which may be used are sulfur compounds with a low oxidation state, such as alkali metal sulfites, for example potassium and/or sodium sulfite, alkali metal hydrogensulfites, for example potassium and/or sodium hydrogensulfite, alkali metal metabisulfites, for example potassium and/or sodium metabisulfite, formaldehydesulfoxylates, for example potassium and/or sodium formaldehydesulfoxylate, alkali metal salts, specifically potassium and/or sodium salts of aliphatic sulfinic acids and alkali metal hydrogensulfides, for example potassium and/or sodium hydrogensulfide, salts of polyvalent metals, such as iron(II) sulfate, iron(II) ammonium sulfate, iron(II) phosphate, ene diols, such as dihydroxymaleic acid, benzoin and/or ascorbic acid, and reducing saccharides, such as sorbose, glucose, fructose and/or dihydroxyacetone. In general, the amount of the free-radical initiator used, based on the total amount of monomers, is 0.01% to 5% by weight, preferably 0.1% to 3% by weight and especially preferably 0.2% to 1.5% by weight.

In the process of the invention, the total amount of the free-radical initiator may be included in the initial charge in the aqueous reaction medium prior to initiation of the polymerization reaction. Alternatively, it is optionally possible to include only a portion of the free-radical initiator in the initial charge in the aqueous reaction medium prior to initiation of the polymerization reaction, and then, under polymerization conditions, to add the total amount or any remaining residual amount during the free-radical emulsion polymerization according to its consumption in a continuous or discontinuous manner.

Initiation of the polymerization reaction is understood to mean the start of the polymerization reaction of the monomers present in the polymerization vessel after the free-radical initiator has formed free radicals. The polymerization reaction can be initiated by addition of free-radical initiator to the aqueous polymerization mixture in the polymerization vessel under polymerization conditions. Alternatively, it is possible that a portion or the entire amount of the free-radical initiator is added to the aqueous polymerization mixture comprising the initially charged monomers in the polymerization vessel under conditions unsuitable for triggering a polymerization reaction, for example at low temperature, and then polymerization conditions are established in the aqueous polymerization mixture. Polymerization conditions are generally understood to mean those temperatures and pressures under which the free-radically initiated aqueous emulsion polymerization proceeds at sufficient polymerization rate. They depend particularly on the free-radical initiator used. Advantageously, the type and amount of the free-radical initiator, the polymerization temperature and the polymerization pressure are selected such that the free-radical initiator has a half life of <3 hours, especially advantageously <1 hour and very particularly advantageously <30 minutes, and there are always sufficient starter free-radicals available to initiate and to maintain the polymerization reaction.

Useful reaction temperatures for the free-radical aqueous emulsion polymerization are the entire range from 0 to 170° C. Temperatures employed are generally 50 to 120° C., preferably 60 to 110° C. and especially preferably 70 to 100° C. The free-radical aqueous emulsion polymerization can be conducted at a pressure of less than, equal to or greater then 1 atm [1.013 bar (absolute), atmospheric pressure], and so the polymerization temperature may exceed 100° C. and may be up to 170° C. In the presence of monomers A to F with a low boiling point, the emulsion polymerization is preferably conducted under elevated pressure. In this case, the pressure may assume values of 1.2, 1.5, 2, 5, 10, 15 bar (absolute) or even higher values. If the emulsion polymerization is conducted under reduced pressure, pressures of 950 mbar, frequently of 900 mbar and often 850 mbar (absolute) are established. Advantageously, the free-radical aqueous emulsion polymerization is conducted at 1 atm with exclusion of oxygen, especially under an inert gas atmosphere, for example under nitrogen or argon.

According to the invention, the aqueous reaction medium may in principle also comprise minor amounts (<5% by weight) of water-soluble organic solvents, for example methanol, ethanol, isopropanol, butanols, pentanols, but also acetone, etc. Preferably, however, the process of the invention is conducted in the absence of such solvents.

As well as the aforementioned components, it is optionally also possible to use free-radical chain-transferring compounds during the emulsion polymerization, in order to reduce or to control the molecular weight of the emulsion polymers obtainable by the polymerization. The compounds used here are essentially aliphatic and/or araliphatic halogen compounds, for example n-butyl chloride, n-butyl bromide, n-butyl iodide, methylene chloride, ethylene dichloride, chloroform, bromoform, bromotrichloromethane, dibromodichloromethane, carbon tetrachloride, carbon tetrabromide, benzyl chloride, benzyl bromide, organic thio compounds, such as primary, secondary or tertiary aliphatic thiols, for example ethanethiol, n-propanethiol, 2-propanethiol, n-butanethiol, 2-butanethiol, 2-methyl-2-propanethiol, n-pentanethiol, 2-pentanethiol, 3-pentanethiol, 2-methyl-2-butanethiol, 3-methyl-2-butanethiol, n-hexanethiol, 2-hexanethiol, 3-hexanethiol, 2-methyl-2-pentanethiol, 3-methyl-2-pentanethiol, 4-methyl-2-pentanethiol, 2-methyl-3-pentanethiol, 3-methyl-3-pentanethiol, 2-ethylbutanethiol, 2-ethyl-2-butanethiol, n-heptanethiol and isomeric compounds thereof, n-octanethiol and isomeric compounds thereof, n-nonanethiol and isomeric compounds thereof, n-decanethiol and isomeric compounds thereof, n-undecanethiol and isomeric compounds thereof, n-dodecanethiol and isomeric compounds thereof, n-tridecanethiol and isomeric compounds thereof, substituted thiols, for example 2-hydroxyethanethiol, aromatic thiols, such as benzenethiol, ortho-, meta-, or para-methylbenzenethiol, and all other sulfur compounds described in the Polymer Handbook 3rd edition, 1989, J. Brandrup and E. H. Immergut, John Wiley & Sons, section II, pages 133 to 141, but also aliphatic and/or aromatic aldehydes, such as acetaldehyde, propionaldehyde and/or benzaldehyde, unsaturated fatty acids, such as oleic acid, dienes with nonconjugated double bonds, such as divinylmethane or vinylcyclohexane, or hydrocarbons having readily abstractable hydrogen atoms, for example toluene. Alternatively, it is possible to use mixtures of the aforementioned free-radical chain-transferring compounds that do not interfere with one another.

The total amount of the free-radical chain-transferring compounds used optionally during the emulsion polymerization, based on the total amount of monomers, is generally ≤5% by weight, often ≤3% by weight and frequently ≤1% by weight.

It is favorable when a portion or the total amount of the free-radical chain-transferring compound optionally used is supplied to the aqueous reaction medium prior to the initiation of the free-radical polymerization. In addition, a portion or the total amount of the free-radical chain-transferring compound can advantageously also be supplied to the aqueous reaction medium together with the monomers A and B during the polymerization.

It is an essential feature that the free-radically initiated aqueous emulsion polymerization can also be conducted in the presence of a polymer seed, for example in the presence of 0.01% to 3% by weight, frequently of 0.02% to 2% by weight and often of 0.04% to 1.5% by weight of a polymer seed, based in each case on the total amount of monomers.

A polymer seed is used especially when the particle size of the polymer particles to be produced by means of a free-radical aqueous emulsion polymerization is to be controlled (in this regard see, for example, U.S. Pat. No. 2,520,959 and U.S. Pat. No. 3,397,165).

More particularly, a polymer seed of which the polymer seed particles have a narrow particle size distribution and weight-average diameters Dw≤100 nm, frequently ≥5 nm to ≤50 nm and often ≥15 nm to ≤35 nm is used. Determination of the weight average particle diameters is known to the person skilled in the art and is carried out, for example, by the analytical ultracentrifugation method. In this document, weight-average particle diameter is understood to mean the weight-average Dw50 value determined by the method of analytical ultracentrifugation (in this regard see S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell-AUC-Multiplexer: High Resolution Particle Size Distribution and Density Gradient Techniques, W. Mächtle, pages 147 to 175).

In the context of this document, a narrow particle size distribution shall be understood to be one where the ratio of the weight-average particle diameter Dw50 determined by the analytical ultracentrifugation method and number-average particle diameter DN50 [Dw50/DN50] is <2.0, preferably <1.5 and especially prefereably <1.2 or <1.1.

Typically, the polymer seed is used in the form of an aqueous polymer dispersion. The amounts stated above are based on the polymer solids content of the aqueous polymer seed dispersion.

If a polymer seed is used, it is advantageous to use an extraneous polymer seed. By contrast with what is called an in situ polymer seed, which is produced in the reaction vessel prior to commencement of the actual emulsion polymerization and which generally has the same monomeric composition as the polymer prepared by the subsequent free-radically initiated aqueous emulsion polymerization, an extraneous polymer seed is understood to mean a polymer seed which has been prepared in a separate reaction step and the monomeric composition of which is different than the polymer prepared by the free-radically initiated aqueous emulsion polymerization, but all this means is that different monomers or monomer mixtures with different composition are used for production of extraneous polymer seed and for production of the aqueous polymer dispersion. The production of an extraneous polymer seed is familiar to the person skilled in the art and is typically effected in such a way that a sufficient amount of polymerization initiator is added at reaction temperature to an initial charge of a relatively small amount of monomers and a relatively large amount of emulsifiers in a reaction vessel.

Preference is given in accordance with the invention to using an extraneous polymer seed with a glass transition temperature of ≥50° C., frequently ≥60° C. or ≥70° C. and often z 80° C. or ≥90° C. A polystyrene polymer seed or a polymethylmethacrylate polymer seed is especially preferred.

The total amount of extraneous polymer seed can be included in the initial charge in the polymerization vessel. Alternatively, it is possible to include only a portion of the extraneous polymer seed in the initial charge in the polymerization vessel and to add the remaining residual amount during the polymerization together with the monomers A and B. If necessary, it is alternatively possible to add the total amount of polymer seed in the course of the polymerization. Preference is given to including the total amount of extraneous polymer seed in the initial charge in the polymerization vessel prior to initiation of the polymerization reaction.

The aqueous polymer P dispersions obtainable by the process of the invention typically have a polymer P solids content of ≥10% and ≤70% by weight, frequently ≥20% and ≤65% by weight and often ≥25% and ≤60% by weight, based in each case on the aqueous polymer P dispersion. The number-average particle diameter (cumulant z-average) determined via quasielastic light scattering (ISO Standard 13 321) is generally in the range of ≥10 and ≤1000 nm, frequently in the range of ≥10 and ≤700 nm and often in the range from ≥50 to ≤250 nm.

It is an essential feature of the process that the free-radically initiated aqueous emulsion polymerization of the monomers A and B is effected in the presence of ≥25% and ≤120% by weight of at least one lignin compound L, based on the total amount of monomers.

Lignins are understood by the person skilled in the art to mean a group of phenolic macromolecules formed from various monomer units, such as p-coumaryl alcohol, coniferyl alcohol and sinapyl alcohol in particular, which are bonded to one another essentially via ether groups. The lignins are solid biopolymers which are incorporated into the cell walls of plants and thus bring about the lignification of a cell. Since lignin in nature is effected via an enzymatic free-radical reaction, the composition and proportions of the individual units are highly variable and there is no directed linkage according to a scheme which is always the same. It is also a significant feature that the lignin from different types of wood or plant differs by the percentages of the aforementioned main components. Thus, the lignin from conifer wood predominantly comprises coniferyl units having a guaiacyl radical (3-methoxy-4-hydroxyphenyl radical). By contrast, the lignin from deciduous wood comprises varying proportions of guaiacyl radicals and sinapyl units, which comprise a syringyl radical (3,5-methoxy-4-hydroxyphenyl radical).

In the production of paper and pulp, lignin, which is troublesome, has to be leached out of the lignocellulose and removed from the process of paper and pulp production. The degradation and the removal of the lignin from the lignocellulose is effected essentially by two methods, namely the sulfate method, also called the Kraft process, and the sulfite method. The degradation and the removal of the lignin by the sulfate method is effected at elevated temperature (about 170° C.) by reacting the lignocellulose (in the wood or other cellulosic plants) with alkali metal sulfides in a highly alkaline medium, especially using sodium sulfide and sodium hydroxide solution. After the cellulose has been removed, the waste liquor from the sulfate method, in its solid matter, has about 45% by weight of what is called Kraft lignin when conifer wood is used and about 38% by weight when deciduous wood is used. In the sulfite method, the degradation and the removal of the lignin is effected by reacting the lignocellulose with sulfurous acid, followed by neutralization with a base, forming what are called lignosulfonates as a reaction product which is not defined exactly in chemical terms. After the cellulose has been removed, the waste liquor from the sulfite method, in its solid matter, has about 55% by weight of lignosulfonate when conifer wood is used and about 42% by weight when deciduous wood is used.

Lignin compounds L of the invention that may be used include any lignin compounds, lignin reaction products and/or lignin degradation products having a solubility at 20° C. and 1 atm (1.013 bar absolute) of a ≥10 g, advantageously ≥50 g and especially advantageously ≥100 g per 100 g of deionized water. However, the invention also encompasses those embodiments wherein the lignin compound L has a solubility of <10 g per 100 g of deionized water at 20° C. and 1 atm. Depending on the amount of these lignin compounds L used, they may then also be in the form of an aqueous suspension thereof. When lignin compounds L, in terms of nature and amount, are used in accordance with the invention such that they are present in aqueous suspension, it is advantageous when the particles of the lignin compound L suspended in aqueous medium have a mean particle diameter of ≤5 μm, preferably ≤3 μm and especially preferably ≤1 μm. The average particle diameters are determined as in the case of the aqueous polymer P dispersions via the method of quasielastic light scattering (ISO Standard 13 321). However, especial preference is given to using lignin compounds L having a solubility at 20° C. and 1 atm of ≥10 g per 100 g of deionized water.

It is advantageous in accordance with the invention to use Kraft lignins and lignosulfonates, especially preferably lignosulfonates. Even though all salts of lignosulfonic acid can be used in the context of the invention, preference is given to using calcium lignosulfonate (CAS No. 8061-52-7), sodium lignosulfonate (CAS No. 8061-51-6), magnesium lignosulfonate (CAS No. 8061-54-9) and/or ammonium lignosulfonate (CAS No. 8061-53-8). Particular preference is given to sodium lignosulfonate and calcium lignosulfonate, especial preference to calcium lignosulfonate. These compounds can be obtained commercially, for example, under the names of Borrement® CA 120, Borresperse® NA 200 or Borresperse® NA 220 from Borregaard Deutschland GmbH or StarLig® Na 2420 from LignoStar Deutschland GmbH. In addition, corresponding products, for example the Bretax® or Sartax® product lines, especially Bretax® CL, from the Burgo Group, Italy, are available on the market. It is advantageous to use lignosulfonates which have been obtained from softwood. Softwood is understood to mean those woods having an oven-dried density of <0.55 g/cm³ (apparent density of wood at 0% wood moisture content [DIN 52183]), such as, more particularly, the woods from fast-growing willow, poplar and linden, and the woods from conifers such as, more particularly, pine, fir, Douglas fir, larch and spruce. It is particularly advantageous to use lignosulfonates which have been obtained from conifers.

It is an essential feature of the invention that the total amount of the lignin compound L can be added to the aqueous polymerization medium before and/or during the emulsion polymerization of the monomers A and B. It is advantageous to include at least a portion of the lignin compound L in the initial charge in the aqueous polymerization medium prior to the initiation of the aqueous emulsion polymerization, and to meter in any remaining residual amount during the initiation of the emulsion polymerization, frequently together with the monomers A and B. In an embodiment which is preferred in accordance with the invention, the total amount of the lignin compound L is included in the initial charge in the aqueous polymerization medium prior to initiation of the polymerization reaction.

In a further embodiment, in accordance with the invention, the total amount of the lignin compound L and ≤10% by weight of the monomers A and B is included in the initial charge in the aqueous polymerization medium prior to initiation of the polymerization reaction.

According to the invention, the amount of lignin compound L is ≥25% and ≤120% by weight, advantageously ≥30% and ≤80% by weight and especially advantageously ≥35% and ≤75% by weight, based in each case on the total amount of monomers.

It is a significant feature that the invention is to include the aqueous polymer P dispersions obtainable by the process of the invention.

It is also a significant feature that the invention is also to include the use of the aqueous polymer P dispersions of the invention as binder for granular and/or fibrous substrates. In this connection, it is also a significant feature that the invention is to include aqueous binder compositions comprising, as an essential component, an aqueous polymer P dispersion obtainable by the process of the invention.

It is an essential feature that the aqueous binder composition of the invention, as well as the aqueous polymer P dispersion and the lignin compound L, may additionally include further components familiar to the person skilled in the art in terms of nature and amount, for example thickeners, pigment distributors, dispersants, emulsifiers, buffer substances, neutralizing agents, biocides, defoamers, polyol compounds having at least 2 hydroxyl groups and a molecular weight of ≤200 g/mol, film-forming aids, organic solvents, pigments or fillers etc.

Advantageously, the aqueous binder composition, however, comprises ≤1% by weight, especially advantageously ≤0.5% by weight, of a polyol compound having at least 2 hydroxyl groups and having a molecular weight of ≤200 g/mol, especially ≤150 g/mol, for example ethylene glycol, propane-1,2-diol, propane-1,3-diol, propane-1,2,3-triol, butane-1,2-diol, butane-1,4-diol, butane-1,2,3,4-tetraol, diethanolamine, triethanolamine etc., based on the sum of the total amounts of polymer P and lignin compound L.

It is likewise a significant feature that the present aqueous binder composition may comprise defatted soy flour with a mesh size of ≤43 μm in amounts which, however, are at least 20% by weight below the amounts disclosed in EP-A 2199320, paragraph [0035]. Particularly advantageously, however, the binder composition of the invention does not comprise any such defatted soy flour.

The aqueous polymer P dispersions of the invention and a binder composition which comprise an aqueous polymer P dispersion as an essential component are advantageously suitable for use as binder for granular and/or fibrous substrates. Advantageously, the aqueous polymer P dispersions mentioned and the binder compositions comprising them can therefore be used in the production of shaped bodies from granular and/or fibrous substrates. In addition, the aqueous polymer P dispersions mentioned and the binder compositions comprising them are suitable as binder in non-cementitious coatings, for example flexible roof coatings, wetroom coatings or spackling compounds, sealing compounds, for example joint sealants and adhesives, for example assembly adhesives, tile adhesives, contact adhesives or floorcovering adhesives.

Granular and/or fibrous substrates are familiar to those skilled in the art. For example, these comprise wood chips, wood fibers, cellulose fibers, textile fibers, polymer fibers, glass fibers, mineral fibers or natural fibers such as jute, flax, hemp or sisal, but also cork chips or sand, and other organic or inorganic natural and/or synthetic granular and/or fibrous compounds, the longest dimension of which in the case of granular substrates is ≤10 mm, preferably ≤5 mm and especially ≤2 mm. The term “substrate” is of course also supposed to include the fiber webs obtainable from fibers, for example what are called mechanically consolidated, for example needled or chemically prebonded, fiber webs. Especially advantageously, the aqueous binder composition of the invention is suitable as a formaldehyde-free or reduced-formaldehyde binder system for the aforementioned fibers and mechanically consolidated or chemically prebonded fiber webs.

The process for producing a shaped body from granular and/or fibrous substrates is effected by applying an aqueous binder composition comprising, as an essential component, an aqueous polymer P dispersion to the granular and/or fibrous substrate (called impregnation), optionally shaping the granular and/or fibrous substrate thus treated, and then subjecting the granular and/or fibrous substrate thus obtained to a thermal treatment step at a temperature of ≥110° C.

The granular and/or fibrous substrate is generally impregnated by applying the aqueous binder composition homogeneously to the surface of the fibrous and/or granular substrate. The amount of aqueous binder composition is chosen here such that ≥1 g and ≤100 g, preferably ≥2 g and ≤50 g and especially preferably ≥5 g and ≤30 g of binder (calculated as the sum of the total amounts of polymer P and lignin compound L based on solids) are used per 100 g of granular and/or fibrous substrate. The impregnation of the granular and/or fibrous substrate is familiar to the person skilled in the art and is effected, for example, by soaking or by spraying the granular and/or fibrous substrate with the aqueous binder composition.

After the impregnation, the granular and/or fibrous substrate is optionally converted to the desired shape, for example by introducing it into a heatable press or mold. Thereafter, the shaped impregnated granular and/or fibrous substrate is dried and cured in a manner familiar to those skilled in the art.

Frequently, the drying or curing of the optionally shaped, impregnated granular and/or fibrous substrate is effected in two temperature stages, in which case the drying stage is effected at a temperature of <100° C., preferably ≥20° C. and ≤90° C. and especially preferably ≥40° C. and ≤80° C., and the curing stage at a temperature of ≥110° C., preferably ≥130 and ≤150° C. and especially preferably ≥180° C. and ≤220° C.

Alternatively, it is of course possible that the drying stage and the curing stage of the shaped bodies are effected in one step, for example in a mold press.

The shaped bodies obtainable by the process of the invention have advantageous properties, such as, more particularly, improved dimensional stability, improved force modulus and reduced elongation at elevated temperature compared to prior art shaped bodies. Accordingly, the invention also includes the shaped bodies obtainable by the aforementioned process.

Especially advantageously, the aqueous binder composition of the invention is therefore suitable for production of fiber webs based on polyester and/or glass fiber, which can in turn be used especially for production of bituminized roofing membranes.

The production of bituminized roofing membranes is familiar to the person skilled in the art, and is especially effected by applying liquefied, optionally modified bitumen to one or both sides of a polyester and/or glass fiber web bound with a binder composition of the invention. Accordingly, the invention also encompasses the aforementioned bituminized roofing membranes.

The invention is to be elucidated by nonlimiting examples which follow.

### EXAMPLES

### Polymer Dispersion D1

A 2 L polymerization vessel equipped with a stirrer, a reflux condenser and metering devices was initially charged, under a nitrogen atmosphere, with 366.9 g of a 47.7% by weight aqueous calcium lignosulfonate solution (Bretax® CL, product from the Burgo Group), 73.7 g of deionized water and 8.3 g of a 15% by weight solution of a fatty alcohol sulfate (Disponil® SDS 15; product from BASF SE). The initially charged mixture was heated to 70° C. while stirring, then the monomer feed, the N-methylolacrylamide feed and the initiator feeds were started simultaneously and metered in over 120 minutes, each at constant flow rates, while maintaining the temperature. The monomer feed consisted of 120.0 g of styrene, 117.5 g of n-butyl acrylate and 2.5 g of butylene glycol 1,4-diacrylate. The N-methylolacrylamide feed consisted of 28.6 g of a 35% by weight aqueous solution of N-methylolacrylamide and 9.4 g of deionized water. The first initiator feed consisted of 75.0 g of a 10% by weight aqueous tert-butyl hydroperoxide solution, and the second initiator feed of 57.0 g of a 10% by weight aqueous solution of sodium hydroxymethylsulfinate (Rongalit® C; product from BASF SE).

After the feeds had ended, the polymerization mixture was stirred at 70° C. for another 1 hour. Thereafter, 25.0 g of a 10% by weight aqueous tert-butyl hydroperoxide solution were metered in at constant flow rate within 30 minutes, and then the polymerization mixture was stirred at 70° C. for another 90 minutes. Subsequently, the aqueous polymer dispersion obtained was cooled down to 20 to 25° C. (room temperature).

The polymer dispersion D1 thus produced had a solids content of 47.8% by weight and an LD value of 78%. A bimodal particle size distribution with one maximum each at 85 and 300 nm was measured.

The solids contents were generally determined by drying a defined amount of the respective aqueous polymer dispersion (about 5 g) to constant weight at 140° C. in a drying cabinet. Two separate measurements were conducted in each case. The value reported in each case is the mean of these two measurements.

A measure of the particle size of the dispersed polymer particles is the LD value. To determine the LD value (transparency), the polymer dispersion to be examined in each case is analyzed in 0.1% by weight aqueous dilution in a cuvette having an edge length of 2.5 cm with light of wavelength 600 nm and compared with the corresponding transparency of deionized water under the same test conditions. The transparency of deionized water was assumed here to be 100%. The finer the dispersion, the higher the LD value which is measured by the method described above. The measurements can be used to calculate the average particle size; cf. B. Verner, M. Bárta, B. Sedlácek, Tables of Scattering Functions for Spherical Particles, Prague, 1976, Edice Marco, Rada D-DATA, SVAZEK D-1.

The number-average particle diameters of the polymer particles were generally determined by dynamic light scattering on a 0.005 to 0.01 percent by weight aqueous polymer dispersion at 23° C. using an Autosizer IIC from Malvern Instruments, England. What is reported is the cumulant z-average diameter of the measured autocorrelation function (ISO Standard 13321).

### Polymer Dispersion D2

Polymer dispersion D2 was produced entirely analogously to the production of polymer dispersion D1, except that 314.5 g rather than 366.9 g of the 47.7% by weight aqueous calcium lignosulfonate solution and 101.1 g rather than 73.7 g of deionized water were used.

The polymer dispersion D1 thus produced had a solids content of 48.1% by weight and an LD value of 74%. A bimodal particle size distribution with one maximum each at 250 and 935 nm was measured.

### Polymer Dispersion D3

Polymer dispersion D3 was produced entirely analogously to the production of polymer dispersion D1, except that 209.6 g rather than 366.9 g of the 47.7% by weight aqueous calcium lignosulfonate solution and 156.0 g rather than 73.7 g of deionized water were used.

The polymer dispersion D1 thus produced had a solids content of 48.4% by weight and an LD value of 63%. A bimodal particle size distribution with one maximum each at 110 and 360 nm was measured.

### Polymer Dispersion D4

A 1.5 L polymerization vessel equipped with a stirrer, a reflux condenser and metering devices was initially charged, under a nitrogen atmosphere, with 293.5 g of a 47.7% by weight aqueous calcium lignosulfonate solution (Bretax® CL, product from the Burgo Group), 36.8 g of deionized water and 6.7 g of a 15% by weight solution of a fatty alcohol sulfate (Disponil® SDS 15). The initially charged mixture was heated to 70° C. while stirring, then the monomer feed and the initiator feeds were started simultaneously and metered in over 120 minutes, each at constant flow rates, while maintaining the temperature. The monomer feed consisted of 96.0 g of styrene, 96.0 g of n-butyl acrylate, 6.0 g of glycidyl methacrylate and 2.0 g of butylene glycol 1,4-diacrylate. The first initiator feed consisted of 60.0 g of a 10% by weight aqueous tert-butyl hydroperoxide solution, and the second initiator feed of 45.6 g of a 10% by weight aqueous solution of sodium hydroxymethylsulfinate (Rongalit® C). After the feeds had ended, a further 38.3 g of deionized water were added to the polymerization mixture and then the polymerization mixture was stirred at 70° C. for another 1 hour. Thereafter, 20.0 g of a 10% by weight aqueous tert-butyl hydroperoxide solution were metered in at constant flow rate within 30 minutes. Subsequently, another 10.3 g of deionized water were added and then the polymerization mixture was stirred at 70° C. for another 90 minutes. Subsequently, the aqueous polymer dispersion obtained was cooled down to room temperature.

The polymer dispersion D4 thus produced had a solids content of 49.2% by weight and an LD value of 78%. A bimodal particle size distribution with one maximum each at 105 and 240 nm was measured.

### Polymer Dispersion D5

Polymer dispersion D5 was produced entirely analogously to the production of polymer dispersion D4, except that 251.6 g rather than 293.5 g of the 47.7% by weight aqueous calcium lignosulfonate solution and 58.7 g rather than 36.8 g of deionized water were used.

The polymer dispersion D5 thus produced had a solids content of 49.7% by weight and an LD value of 72%. The number-average particle diameter was determined as 265 nm.

### Polymer Dispersion D6

Polymer dispersion D6 was produced entirely analogously to the production of polymer dispersion D4, except that 167.7 g rather than 293.5 g of the 47.7% by weight aqueous calcium lignosulfonate solution and 102.6 g rather than 36.8 g of deionized water were used.

The polymer dispersion D6 thus produced had a solids content of 49.1% by weight and an LD value of 55%. A bimodal particle size distribution with one maximum each at 85 and 340 nm was measured.

### Polymer Dispersion D7

Polymer dispersion D7 was produced entirely analogously to the production of polymer dispersion D1, except that the monomer feed consisted of 120.0 g of styrene and 117.5 g of n-butyl acrylate, and the N-methylolacrylamide feed of 35.7 g of a 35% by weight aqueous solution of N-methylolacrylamide and 9.4 g of deionized water.

The polymer dispersion D6 thus produced had a solids content of 48.0% by weight and an LD value of 76%. A bimodal particle size distribution with one maximum each at 95 and 235 nm was measured.

### Polymer Dispersion D8

Polymer dispersion D8 was produced entirely analogously to the production of polymer dispersion D4, except that the monomer feed consisted of 96.0 g of styrene, 96.0 g of n-butyl acrylate and 8.0 g of glycidyl methacrylate.

The polymer dispersion D8 thus produced had a solids content of 49.0% by weight and an LD value of 75%. A bimodal particle size distribution with one maximum each at 90 and 300 nm was measured.

### Polymer Dispersion D9

Polymer dispersion D9 was produced entirely analogously to the production of polymer dispersion D4, except that the monomer feed consisted of 97.0 g of styrene, 97.0 g of n-butyl acrylate and 6.0 g of butylene glycol 1,4-diacrylate.

The polymer dispersion D9 thus produced had a solids content of 48.9% by weight and an LD value of 77%. A bimodal particle size distribution with one maximum each at 100 and 245 nm was measured.

### Comparative Dispersion C1

Comparative dispersion C1 was produced entirely analogously to the production of polymer dispersion D1, except that 4.5 g of an aqueous polystyrene seed latex (solids content 33% by weight; having a weight average particle diameter of 28 nm) and 444.4 g of a 2.0% by weight solution of a fatty alcohol sulfate (Disponil® SDS 15) were used as initial charge.

The dispersion polymer coagulated about 30 minutes after addition of the 25.0 g of a 10% by weight aqueous tert-butyl hydroperoxide solution.

### Comparative Dispersion C2

Comparative dispersion C2 was produced entirely analogously to the production of polymer dispersion D4, except that 3.6 g of an aqueous polystyrene seed latex (solids content 33% by weight; having a weight average particle diameter of 28 nm) and 333.4 g of a 2.0% by weight solution of a fatty alcohol sulfate (Disponil® SDS 15) were used as initial charge.

The lignosulfonate-free comparative dispersion C2 thus produced had a solids content of 30.4% by weight and an LD value of 63%. The number-average particle diameter was determined as 155 nm.

### Comparative Dispersion C3

Comparative dispersion C3 was produced entirely analogously to the production of polymer dispersion D4, except that the monomer feed consisted of 95.0 g of styrene, 95.0 g of n-butyl acrylate, 6.0 g of glycidyl methacrylate, 2.0 g of butylene glycol 1,4-diacrylate and 2.0 g of acrylic acid.

The comparative dispersion C3 thus produced had a solids content of 49.8% by weight and an LD value of 62%. A bimodal particle size distribution with one maximum each at 80 and 330 nm was measured.

### Comparative Dispersion C4

Comparative dispersion C4 was produced entirely analogously to the production of polymer dispersion D4, except that the monomer feed consisted of 98.0 g of styrene, 98.0 g of n-butyl acrylate, 2.0 g of glycidyl methacrylate and 2.0 g of butylene glycol 1,4-diacrylate.

The comparative dispersion C4 thus produced had a solids content of 50.1% by weight and an LD value of 68%. A bimodal particle size distribution with one maximum each at 105 and 355 nm was measured.

### Comparative Dispersion C5

Comparative dispersion C5 was produced entirely analogously to the production of polymer dispersion C3, except that 48.0 g of deionized water and 3.6 g of an aqueous polystyrene seed latex (solids content 33% by weight; having a weight average particle diameter of 28 nm) were initially charged, the monomer feed was in the form of a homogeneous aqueous emulsion consisting of 103 g of deionized water, 26.7 g of a 15% by weight aqueous solution of a fatty alcohol sulfate (Disponile SDS 15), 95.0 g of styrene, 95.0 g of n-butyl acrylate, 6.0 g of glycidyl methacrylate, 2.0 g of butylene glycol 1,4-diacrylate and 2.0 g of acrylic acid, the initiator feed 1 used was 16.3 g of a 7% by weight aqueous sodium peroxodisulfate solution, and the residual monomers were removed by means of 4.0 g of a 10% by weight aqueous solution of tert-butyl hydroperoxide and 5.0 g of a 13.1% by weight aqueous solution of acetone bisulfite (1:1 addition product of acetone and sodium hydrogensulfite).

The comparative dispersion C5 thus produced had a solids content of 50.0% by weight and an LD value of 63%. The number-average particle diameter was determined as 155 nm.

### II Performance Studies

For production of the bound fiber webs, the raw web used was a needled polyethylene terephthalate spun bonded web (length 400 cm, width 40 cm) having a basis weight of 155 g/m².

For production of the binder liquors, portions of the aqueous polymer dispersions D1 to D9 and the comparative dispersions C2 to C5 were diluted with deionized water to a solids content of 15% by weight. The binder liquors obtained are referred to hereinafter as binder liquors BD1 to BD9 and BC2 to BC5.

In addition, portions of the comparative dispersion C2 were mixed with a 47.7% by weight calcium lignosulfonate solution (Bretax® CL) so as to obtain mixtures wherein the ratio of dispersion polymer to calcium lignosulfonate was 100/70, 100/60 and 100/40. These mixtures were likewise diluted with deionized water to a solids content of 15% by weight. The binder liquors thus obtained are referred to hereinafter as binder liquors BC2-1 to BC2-3.

To produce the bound fiber webs, the raw webs were soaked in a Mathis HVF impregnation system with pad mangle (rubber roll Shore A=85°/steel roll) in longitudinal direction with the respective binder liquor binder liquors BD1 to BD9, BC2 to BC5 and BC2-1, BC2-2 and BC2-3. In each case, the wet pickup was adjusted to 166.7 g of binder liquor per square meter (corresponding to a solids content of 25 g/m²). Subsequently, the impregnated fiber webs obtained were dried and cured in a Fleissner industrial drier at 200° C. for 3 minutes. The bound fiber webs obtained after cooling to room temperature are referred to, depending on the binder liquors used, as fiber webs F1 to F9 and FC2 to FC5 and FC2-1, FC2-2, FC2-3.

The bound fiber webs F1 to F9 and FC2 to FC5 and FC2-1, FC2-2, FC2-3 were used to conduct the following measurements: tensile force at 180° C. and 15% elongation, thermal dimensional stability at 200° C. and elongation at 180° C. and 40 N/5 cm.

### Tensile Force at 180° C. and 15% Elongation, and Elongation at a Tensile Force of 40 N/5 cm

The determinations were effected by means of a ultimate tensile strength machine from Zwick (model: Z10) with integrated equilibration chamber. For this purpose, 50×210 mm strips (longitudinal direction) were punched out of the fiber webs F1 to F9 and FC2 to FC5 and FC2-1, FC2-2, FC2-3 in longitudinal direction and clamped in the pulling device with a clamped length of 100 mm. After introduction into the equilibration chamber, the respective test strip was equilibrated at 180° C. for 60 seconds and then elongated with rising tensile force at this temperature with a pulling speed of 150 mm/min. On attainment of a tensile force of 40 N/5 cm, the elongation of the test strips in percent was determined. In addition, on attainment of an elongation of the test strip of 15%, the respective tensile force in N/5 cm was determined. The results obtained are listed in table 1. The lower the elongation obtained or the higher the respective tensile force, the better the assessment of the results obtained. 5 separate measurements were conducted in each case. The values reported in table 1 are the averages of these measurements.

### Shrinkage in Transverse Direction at 200° C.

Shrinkage in transverse direction at 200° C. was determined in accordance with DIN 18192. For this purpose, 100×340 mm strips were punched out of the fiber webs F1 to F9 and FC2 to FC5 and FC2-1, FC2-2, FC2-3 in longitudinal direction. Proceeding in each case from the two narrow ends, at a distance of 120 mm in each case, the fiber web strips were marked in the middle, giving a measurement distance between the marks of 100 mm. In the region of the middle of this measurement distance, the width of the fiber web strip was monitored by measurement. Thereafter, the narrow ends were clamped in clamping rails.

In parallel, in a drying cabinet, the clamp stand required for the measurement and a stainless steel cylinder of weight 4 kg were heated to 200° C. For testing, the marked and measured fiber web strips were then mounted hanging by means of one clamping rail on the clamp stand within the drying cabinet. Thereafter, the stainless steel cylinder of weight 4 kg was hung on the lower clamping rail, the drying cabinet door was closed, and the fiber web thus clamped was left in the drying cabinet at 200° C. for 10 minutes. Thereafter, the laboratory clamp stand along with the weighted fiber web strip was taken out of the drying cabinet and cooled down at room temperature for 5 minutes. Thereafter, first the stainless steel cylinder was removed from the lower clamping rail and then the upper clamping rail was removed from the clamp stand (the clamp stand and stainless steel cylinder were put back into the drying cabinet for equilibration for the next measurement). After the upper and lower clamping rails had been removed, the fiber web strip was placed flat onto the laboratory bench and the respective distance at the narrowest point in transverse direction of the fiber web strips was measured. Measurements were conducted on 6 separate measurement strips in each case. The values likewise reported in the table are the averages of these measurements. The smaller the shrinkage in transverse direction, the better the assessment of the results. What is reported is the change in transverse direction in percent, based on the corresponding distances before the thermal treatment.

TABLE 1
Measurement results for the performance tests conducted

| | Tensile force at | Elongation at | Shrinkage in |
|---|---|---|---|
| | 180° C. and | 180° C. and | transverse direction |
| | 15% elongation | 40 N/5 cm | at 200° C. |
| Fiber web | [N/5 cm] | [%] | [%] |
| F1 | 71 | 4.0 | −2.1 |
| F2 | 65 | 4.6 | −1.7 |
| F3 | 68 | 4.7 | −2.5 |
| F4 | 70 | 4.5 | −2.9 |
| F5 | 69 | 4.8 | −3.0 |
| F6 | 76 | 4.9 | −3.4 |
| F7 | 68 | 4.2 | −2.3 |
| F8 | 67 | 4.7 | −3.1 |
| F9 | 66 | 4.6 | −3.2 |
| FC2 | 55 | 9.0 | −12.8 |
| FC2-1 | 47 | 8.0 | −10.1 |
| FC2-2 | 54 | 6.0 | −7.7 |
| FC2-3 | 56 | 6.0 | −7.7 |
| FC3 | 58 | 5.5 | −4.3 |
| FC4 | 51 | 6.0 | −5.0 |
| FC5 | 50 | 10.8 | −14.0 |

It is clearly evident from the results that the fiber webs bonded using the binder compositions of the invention exhibit distinctly elevated tensile force values at an elongation of 15%, lower elongation at a tensile force of 40 N/5 cm, and lower shrinkage in transverse direction.

1: A process for preparing an aqueous dispersion of a polymer P, the process comprising:
conducting a free-radically initiated aqueous emulsion polymerization, which comprises polymerizing
>3% and ≤8% by weight of a monomer A, comprising: a monoethylenically unsaturated compound having at least one epoxy group and/or one N-methylol group and/or a compound having at least two nonconjugated ethylenically unsaturated groups, and
≥92% and <97% by weight of a monomer B, comprising: an ethylenically unsaturated compound different from the monomer A, wherein a polymer formed solely from the ethylenically unsaturated compound in polymerized form have a glass transition temperature of ≥0° C. and ≤50° C.,
wherein amounts of the monomers A and B add up to 100% by weight, in the presence of ≥25% and ≤120% by weight of at least one lignin compound L, based on the total amount of monomers, and
wherein the monomer B does not include any ethylenically unsaturated C₃ to C₆ monocarboxylic acids and/or C₄ to C₆ dicarboxylic acids and salts and anhydrides thereof or monoethylenically unsaturated compounds having at least one silicon-containing group, a hydroxyalkyl group or a carbonyl group.

2: The process according to claim 1,
wherein the monomer A is at least one selected from the group consisting of N-methylolacrylamide, N-methylolmethacrylamide, glycidyl acrylate, glycidyl methacrylate, butylene glycol 1,4-diacrylate, allyl methacrylate and divinylbenzene.

3: The process according to claim 1,
wherein the monomer B is selected from the group consisting of a conjugated aliphatic C₄ to C₉ diene, an ester of vinyl alcohol and a C₁ to C₁₀ monocarboxylic acid, a C₁- to C₁₀-alkyl acrylate, a C₁- to C₁₀-alkyl methacrylate, an ethylenically unsaturated C₃ to C₆ monocarbonitrile, an ethylenically unsaturated C₄ to C₆ dicarbonitrile, a C₅- to C₁₀-cycloalkyl acrylate and a methacrylate, a C₁- to C₁₀-dialkyl maleate and a C₁- to C₁₀-dialkyl fumarate and a vinylaromatic monomer.

4: The process according to claim 1,
wherein the polymerizing comprises polymerizing:
≥3.5% and ≤7% by weight of the monomer A, and
≥93% and ≤96.5% by weight of the monomer B.

5: The process according to claim 1,
wherein the polymerizing comprises polymerizing:
≥3.5% and ≤5.5% by weightof the monomer A, which is at least one selected from the group consisting of N-methylolacrylamide, N-methylolmethacrylamide, glycidyl acrylate, glycidyl methacrylate, butylene glycol 1,4-diacrylate, allyl methacrylate and divinylbenzene, and
≥94.5% and ≤96.5% by weight of the monomer B, which is at least one selected from the group consistingof 2-ethylhexyl acrylate, n-butyl acrylate, acrylonitrile, 1,4-butadiene, ethyl acrylate, vinyl acetate, methyl methacrylate, styrene and tert-butyl methacrylate.

6: The process according to claim 1,
wherein the at least one lignin compound L is a lignosulfonate.

7: The process according to claim 1,
wherein the at least one lignin compound L is present at ≥30 and ≤80 parts by weight.

8: An aqueous polymer P dispersion obtained by the process according to claim 1.

9: A binder for at least one granular and/or fibrous substrate, comprising the aqueous polymer P dispersion of claim 8.

10: A process for producing a shaped body from at least one granular and/or fibrous substrate, the process comprising:
applying an aqueous binder composition comprising, as an essential component, the aqueous polymer P dispersion according to claim 8 to the at least one granular and/or fibrous substrate, optionally shaping the at least one granular and/or fibrous substrate thus treated, and subjecting the at least one granular and/or fibrous substrate thus obtained to a thermal treatment at a temperature of ≥110° C.

11: The process according to claim 10,
wherein an amount of the aqueous binder composition is chosen such that ≥1 and ≤100 g of a binder, which corresponds to the sum of the total amounts of the polymer P and the at least one lignin compound L, are applied per 100 g of the at least one granular and/or fibrous substrate.

12: A shaped body obtained by the process according to claim 10.

13: A process for producing a bituminized roofing membrane, the process comprising:
producing the bituminized roofing membrane with the shaped body according to claim 12.

14: A bituminized roofing membrane produced by the process according to claim 13.
